(19) United States
(12) Patent Application Publication
(10) Pub. No.: US 2017/0085665 A1
(43) Pub. Date: Mar. 23, 2017

(54) Filter Covering-Based Notification Routing without Comparing Filters Based on Filtering Languages

(71) Applicant: Futurewei Technologies, Inc., Plano, TX (US)

(72) Inventors: LI Li, Bridgewater, NJ (US); Wu Chou, Basking Ridge, NJ (US)

(21) Appl. No.: 14/858,942

(22) Filed: Sep. 18, 2015

(51) Int. Cl. H04L 29/08

(52) U.S. Cl. CPC H04L 67/2809; H04L 67/10; H04L 67/06; H04L 67/02

(57) ABSTRACT

A method for filter covering-based notification routing implemented in an event broker, comprising receiving a first subscription and a second subscription, creating the first filter and the second filter in the event broker, wherein the first filter and the second filter implement a filter service provider interface (SPI), forwarding the first subscription and the second subscription to an event source, receiving notifications according to the first subscription and the second subscription, determining a first set of the notifications that satisfies the first filter and the second filter and a second set of the notifications that satisfies the second filter, calculating a first number of the notifications in the first set of the notifications and a second number of the notifications in the second set of the notifications, and determining the first filter covers the second filter when the first number is equal to the second number.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Distributed event-based systems find wide applications in many communication systems and networks such as clouds, internet of things (IoT), and Software-defined Networks (SDN). In the distributed event-based systems, notifications are generated by event sources according to subscriptions from event sinks and are routed from the event sources to the event sinks through interconnected event brokers. For real-time communications, the event sinks may receive the notifications from a large number of event sources such as virtual machines, traffic lights, switches, and phones.

The subscriptions may describe general properties of the notifications that the event sinks want to receive from the event sources. For example, the event sinks may transmit subscriptions for new books to the event sources. In response to the subscription, the event sources may send a notification to the event sinks whenever a new book is released. However, the event sinks may only want to receive certain categories of new books. For example, the event sinks may only want to receive new parenting books, not new romance books. Therefore, the event sinks may receive many unnecessary notifications from the event sources based on the subscriptions.

One method to reduce the unnecessary notifications from the event sources is content-based filtering. During content-based filtering, the event sinks transmit filters in addition to the subscriptions to the event sources using interconnected event brokers within a network in order to restrict the notifications that the event sinks receive. For example, the event sinks may transmit a filter for new parenting books to the event sources through the event brokers of the network. By doing so, the event sinks only receive new books corresponding to parenting.

### SUMMARY

In an embodiment, the disclosure includes a filter manager of an event broker, comprising a receiver configured to receive a package uniform resource identifier (URI) from an event sink, wherein the package URI links to a filter package stored in a package server, and wherein the filter package includes URIs of a plurality of filters, a processor operably coupled to a memory and the receiver, wherein the processor is configured to transmit a request for the filter package to the package server according to the package URI, receive the filter package from the package server in response to the request for the filter package, and unpack the filter package to obtain the plurality of filters according to the URIs of the plurality of filters following receipt of the filter package.

In another embodiment, the disclosure includes a method for filter covering-based notification routing implemented in an event broker, comprising receiving, by a filter manager, a first subscription and a second subscription from a child node, transmitting, by the filter manager, a request for a first filter and a second filter to a package server, wherein the first filter corresponds to the first subscription and the second filter corresponds to the second subscription, receiving, by the filter manager, a filter package from the package server, creating, by the filter manager, the first filter and the second filter in the event broker based on the filter package, wherein the first filter and the second filter implement a filter service provider interface (SPI), forwarding, by the filter manager, the first subscription and the second subscription to an event source after the first filter and the second filter have been created, receiving, by the filter manager, notifications corresponding to the first subscription and the second subscription from one of the event source and an event source simulator in response to the first subscription and the second subscription having been forwarded, determining, by the filter manager, a first number of the notifications in a first set of the notifications and a second number of the notifications in a second set of the notifications, wherein the first set of the notifications satisfies both the first filter and the second filter, and wherein the second set of the notifications satisfies the second filter, and comparing, by the first manager, the first number and the second number, wherein the first filter covers the second filter when the first number is equal to the second number.

In yet another embodiment, the disclosure includes an event broker, comprising a receiver configured to receive a first subscription and a second subscription from a child node, a processor operably coupled to a memory and the receiver, wherein the processor is configured to transmit a request for a first filter and a second filter to a package server, wherein the first filter corresponds to the first subscription and the second filter corresponds to the second subscription, receive a filter package from the package server, create the first filter and the second filter in the event broker based on the filter package, wherein the first filter and the second filter implement a filter SPI, forward the first subscription and the second subscription to an event source after the first filter and the second filter have been created, receive notifications corresponding to the first subscription and the second subscription from one of the event source and an event source simulator in response to the first subscription and the second subscription having been forwarded, determine a first number of the notifications in a first set of the notifications and a second number of the notifications in a second set of the notifications, wherein the first set of the notifications satisfies both the first filter and the second filter, and wherein the second set of the notifications satisfies the second filter, and compare the first number and the second number, wherein the first filter covers the second filter when the first number is equal to the second number.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram illustrating filter-covering relationships.

FIG. 2 is a schematic diagram of a distributed event-based system according to an embodiment of the disclosure.

FIG. 3 is a schematic diagram of an event broker configuration according to an embodiment of the disclosure.

FIG. 4 is a protocol diagram illustrating filter deployment during subscriptions according to an embodiment of the disclosure.

FIG. 5 is a schematic diagram of another event broker configuration according to an embodiment of the disclosure.

FIG. 6 is a diagram illustrating a first filter-covering relationship according to an embodiment of the disclosure.

FIG. 7 is a diagram illustrating a second filter-covering relationship according to an embodiment of the disclosure.

FIG. 8 is a diagram illustrating a third filter-covering relationship according to an embodiment of the disclosure.

FIG. 9 is a diagram illustrating state transitions according to an embodiment of the disclosure.

FIG. 10 is a protocol diagram illustrating filter covering-based notification routing according to an embodiment of the disclosure.

FIG. 11 is a flowchart illustrating a method of filter covering-based notification routing according to an embodiment of the disclosure.

FIG. 12 is a schematic diagram of a network element (NE) according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

One problem of content-based filtering is that the event sources may transmit redundant notifications to the event sinks according to the filters when a filter-covering relationship is satisfied. The filter-covering relationship indicates that a first filter covers a second filter when a set of the notifications that satisfy the first filter is a superset of a set of the notifications that satisfy the second filter. For example, when the first filter requests for the new books with prices below $20 and the second filter requests for the new books with prices below $15, the filter-covering relationship that the first filter covers the second filter is satisfied. As a result, the notifications that satisfy the second filter are included in the notifications that satisfy the first filter. In other word, the notifications that satisfy the second filter are redundant notifications because they are transmitted twice when the event sources transmit the notifications according to both the first filter and the second filter.

A large amount of the redundant notifications may congest the network between the event sinks and the event sources. In order to reduce the redundant notifications, the event sources may unsubscribe the second filter and transmit the notifications according to the first filter when the first filter covers the second filter. This technique is called “covering-based routing.” In the existing solutions, the filter-covering relationship is determined by comparing the filters based on the filtering languages that express the filters.

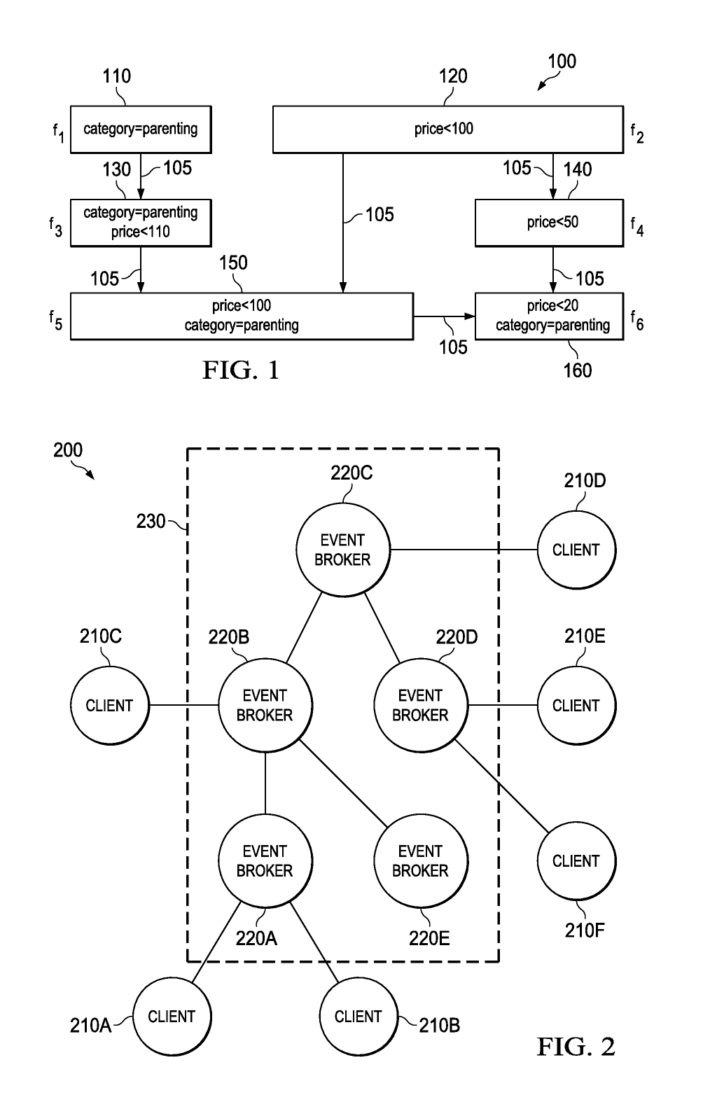

FIG. 1 is a diagram 100 illustrating filter-covering relationships. The diagram 100 illustrates the filter-covering relationships among six filters including a first filter (f₁) 110, a second filter (f₂) 120, a third filter (f₃) 130, a fourth filter (f₄) 140, a fifth filter (f₅) 150, and a sixth filter (f₆) 160 connected by arrows 105. In the filter-covering relationships, the filter that the arrow 105 leaves covers the filter that the arrow is pointing at. For example, f₁ 110 covers f₃ 130, f₃ 130 covers f₅ 150, f₅ 150 covers f₆ 160, f₂ 120 covers both f₄ 140 and f₅ 150, and f₄ 140 covers f₆ 160. As mentioned above, all the filters 110, 120, 130, 140, and 150 may be expressed in one or more filtering languages. The diagram 100 is determined in the event sources and/or the event brokers by comparing the filters by analyzing the one or more filtering languages. For example, the filter language “price <100” of f₂ 120 is less restrictive than the filter language “price <50” of f₄ 140 when the filters are applied to the same notifications. As the result, a first set of the notifications satisfying the restriction by f₂ 120 is a superset of a second set of the notifications satisfying the restriction by f₄ 140. Therefore, it is determined that f₂ 120 covers f₄ 140.

TABLE 1
Content languages and corresponding filtering languages

| Content Language | Filtering Language |
|---|---|
| HTML | ? |
| XML | XPath, XQuery |
| JSON | JSON Path |
| RDF | SPARQL |
| YAML | ? |
| Atom | ? |
| Rss | ? |

Table 1 shows some common content languages that may express the notifications and the corresponding filtering languages that may express the filters (e.g., f₁ 110, f₂ 120, f₃ 130, f₄ 140, f₅ 150, and f₆ 160). In a heterogeneous service-oriented architecture (SOA), the notifications may be expressed in various content languages as listed in Table 1. The event sources determine the content languages and the corresponding filtering languages. The event brokers of the network between the event sources and the event sinks forward the subscriptions and the notifications and do not determine the content language or the filtering languages. Such SOA impose some technical issues on determining filter-covering relationships based on the filtering languages. First, it is difficult to ensure that the event brokers understand all the content languages and the filtering languages to determine the filter-covering relationships, particularly when the numbers of the content languages and the filtering languages increase with time. Second, some content languages (e.g., Hyper Text Markup Language (HTML), Yet Another Markup Language (YAML), Atom, and Rich Site Summary (RSS)) may not have corresponding filtering languages. Therefore, the event brokers cannot determine the filter-covering relationships based on the filtering languages. Third, it is difficult to determine the filter-covering relationships between the filters expressed in some specific filtering languages due to lack of efficient comparing algorithm. For example, such specific filtering languages may include extensible markup language query (XQuery) and simple protocol and resource description framework (RDF) query language (SPARQL). Fourth, it is difficult to determine the filter-covering relationships between the filters expressed in different filtering languages (e.g., XQuery and SPARQL). Fifth, the exposure of the filtering languages to the event brokers may increase security threats to the event sources and/or the event sinks. Therefore, a need exists for an alternative filter covering-based notification routing scheme without determining the filter-covering relationships based on the filtering languages.

Disclosed herein are various embodiments for filter covering-based notification routing without comparing filters based on filtering languages. Event sinks communicate the subscriptions to the event sources. Each subscription includes a uniform resource identifier (URI) of one of the filters, which consist of executable code packaged by a package server. In an embodiment, the package server is one of the event sinks. In an embodiment, the package server is a server in communication with the event sinks. The event sinks further transmit the subscriptions to the event sources through a plurality of event brokers within a network. All event brokers in a path connecting the event sinks and the event sources may receive the subscriptions. In addition, all the event brokers in the path connecting the event sinks and the event sources receive the filter packages from the package server, unpack the filter packages to obtain URIs of the filters, load the filters into the memory according to the URIs of the filters, and register the filters in filter registrations of the event brokers. Each of the filter registrations designates a filter service provider interface (SPI). The event brokers may invoke the filters through the filter SPI without knowing the filtering languages of the filters. One of the event brokers in the path connecting the event sinks and the event sources may be selected to determine a filter-covering relationship between any two of the filters based on the outcome of invoking the filters. For example, the selected event broker receives notifications from the event sources or event source simulators corresponding to a first filter and a second filter. Following receipt of the notifications, the selected event broker determines a first set of the notifications that satisfy both the first filter and the second filter. The selected event broker further determines a second set of the notifications that satisfy the second filter. A first number represents the cardinality of the first set of the notifications, which indicates a total number of the notifications in the first set. A second number represents the cardinality of the second set of the notifications, which indicates a total number of the notifications in the second set. The selected event broker determines a probability by dividing the first number by the second number. When the probability is equal to 1 (i.e., the first number is equal to the second number), it is determined that the first filter covers the second filter indicating the second set of the notifications that satisfies the second filter are redundant notifications. When the probability is not equal to 1, it is determined the first filter does not cover the second filter. When the first filter covers the second filter, the selected event broker informs its parent event broker to unsubscribe the second filter. The parent event broker is a neighboring event broker of the selected event broker in the path closer to the event sources. The parent event broker unsubscribes the second filter and informs its parent event broker to unsubscribe the second filters, and so on, until the event sources are informed to unsubscribe the second filters. Finally, the event sources unsubscribe the second filter so that they only transmit notifications that satisfy the first filter to the event sinks over the network. As a result, the redundant notifications (e.g., the second set of the notifications) from the event sources due to the second filter are reduced.

Since the filter-covering relationships are determined based on the outcome of invoking the filters rather than examining the filtering languages, the method for filter covering-based notification routing may be implemented in a distributed event-based system in an attempt to resolve the issues noted above. In addition, the method is efficient in performing the filter covering-based notification routing and is compatible with the existing distributed event-based systems. Moreover, the distributed event-based systems that employ the method may be scalable and more secure for the event sources and event sinks by hiding the filtering languages.

FIG. 2 is a schematic diagram of a distributed event-based system 200 according to an embodiment of the disclosure. The distributed event-based system 200 comprises a plurality of clients such as clients 210A, 210B, 210C, 210D, 210E, and 210F connected with a network 230. Each of the clients 210A, 210B, 210C, 210D, 210E, and 210F may be a laptop, a tablet computer, a desktop computer, a mobile telephone, or any other device, and may be configured as an event sink, an event source, or both. The event sinks are configured to transmit subscriptions to the event sources and receive notifications from the event sources based on the subscriptions over the network 230. The event sources are configured to transmit the notifications to the event sinks based on the subscriptions over the network 230.

The network 230 comprises a plurality of event brokers such as event brokers 220A, 220B, 220C, 220D, and 220E interconnected with links 240. Each of the event brokers 220A, 220B, 220C, 220D, and 220E may be configured to communicate messages (e.g., the notifications, the subscriptions, and/or other messages) with the clients 210A, 210B, 210C, 210D, 210E, and 210F and forward the messages inside the network 230. In an embodiment, the links 240 may be physical links such as electrical cables and/or optical fibers. In an embodiment, the links 240 may be virtual links or wireless links. The clients 210A, 210B, 210C, 210D, 210E, and 210F communicate with the event brokers 220A, 220B, 220C, 220D, and 220E of the network 230 by using client-server protocols such as Hypertext Transfer Protocol (HTTP) and/or Extensible Messaging and Presence Protocol (XMPP).

In an embodiment as shown in FIG. 2, the client 210A and the client 210B are event sinks, and the client 210E and the client 210F are event sources. Both the event sinks (e.g., the client 210A and the client 210B) transmit the subscriptions to the event sources (e.g., the client 210E and the client 210F) through the event broker 220A, the event broker 220B, the event broker 220C, and the event broker 220D, which collectively establish a path connecting the event sinks (e.g., the client 210A and the client 210B) and the event sources (e.g., the client 210E and the client 210F). Similarly, both the event sources (e.g., the client 210E and the client 210F) transmit notifications based on the subscriptions to the event sinks (e.g., the client 210A and the client 210B) through the same path in order of the event broker 220D, the event broker 220C, the event broker 220B, and the event broker 220A.

Each of the event brokers in the path (e.g., the event brokers 220A, 220B, 220C, and 220D) is coupled to a child event broker, a parent event broker, or both. The child event broker refers to a neighboring event broker in the path that is closer to the event sinks. The parent event broker refers to a neighboring event broker in the path that is closer to the event sources. For example, the event broker 220A is a child event broker of the event broker 220B and does not have a parent event broker. The event broker 220B is a parent event broker of the event broker 220A and a child event broker of the event broker 220C. The event broker 220D is a parent event broker of the event broker 220C and does not have a parent event broker.

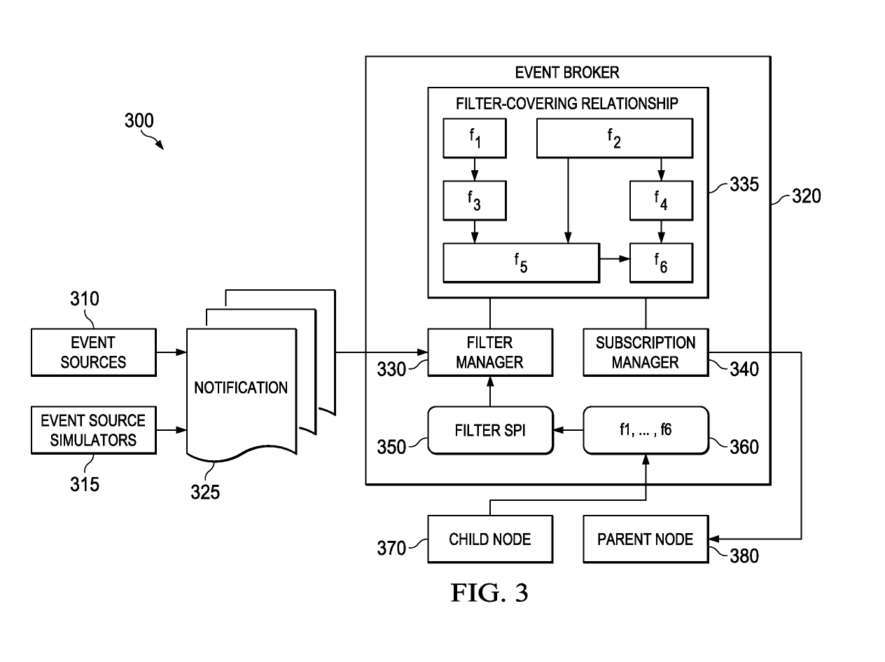

FIG. 3 is a schematic diagram of an event broker configuration 300 according to an embodiment of the disclosure. The event broker configuration 300 illustrates an event broker 320 (e.g., any one of the event brokers 220A, 220B, 220C, and 220D) configured to implement filter covering-based notification routing. The event broker 320 comprises a filter manager 330, a subscription manager 340, a filter service provider interface (SPI) 350, a plurality of filters 360 and a data structure 335 indicating filter-covering relationship between the filters 360. The filters 360 may be similar to the filters 110-160 in FIG. 1. The data structure 335 indicates the filter-covering relationships and may be similar to the diagram 100 with the filter languages hidden from the event broker.

The event broker 320 is coupled to a child node 370, which may be a child event broker or the event sinks (e.g., the client 210A and the client 210B). The event broker 320 is further coupled to a parent node 380, which may be a parent event broker or event sources 310 (e.g., the client 210E and the client 210F). For example, when the event broker 320 is the event broker 220A in FIG. 2, the child node 370 represents the event sinks (e.g., the client 210A and the client 210B), and the parent node 380 represents a parent event broker (e.g., the event broker 220B). When the event broker 320 is the event broker 220B, the child node 370 represents a child event broker (e.g., the event broker 220A), and the parent node 380 represents a parent event broker (e.g., the event broker 220C). When the event broker 320 is the event broker 220D, the child node 370 represents a child event broker (e.g., the event broker 220C), and the parent node 380 represents the event sources (e.g., the client 210E and the client 210F).

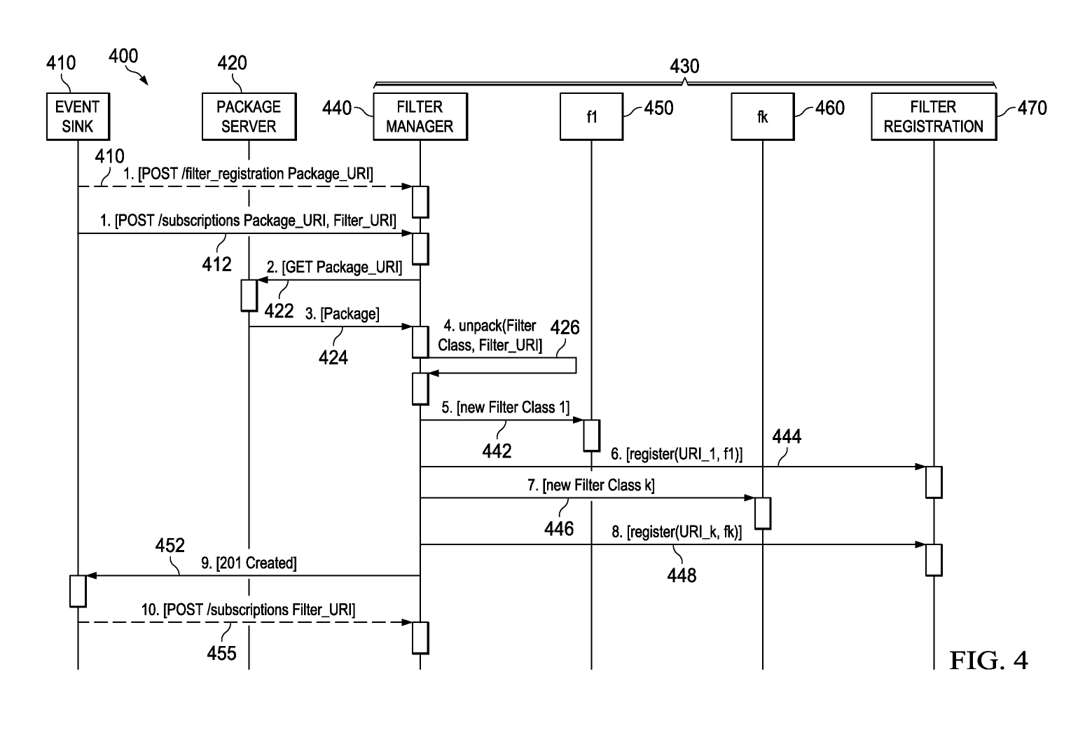

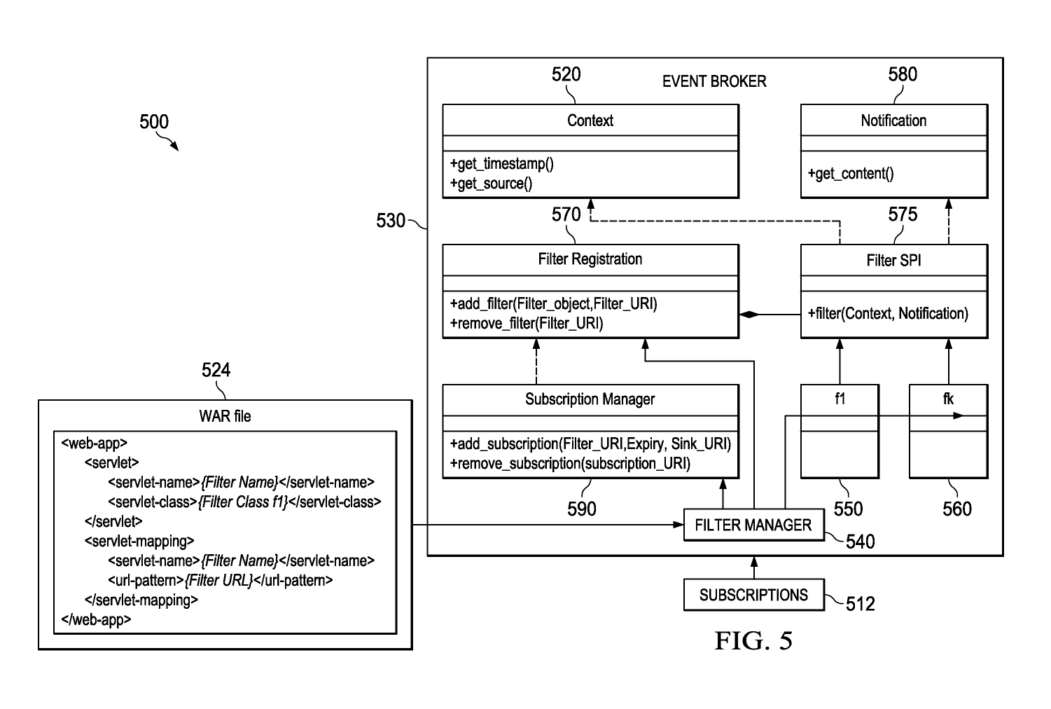

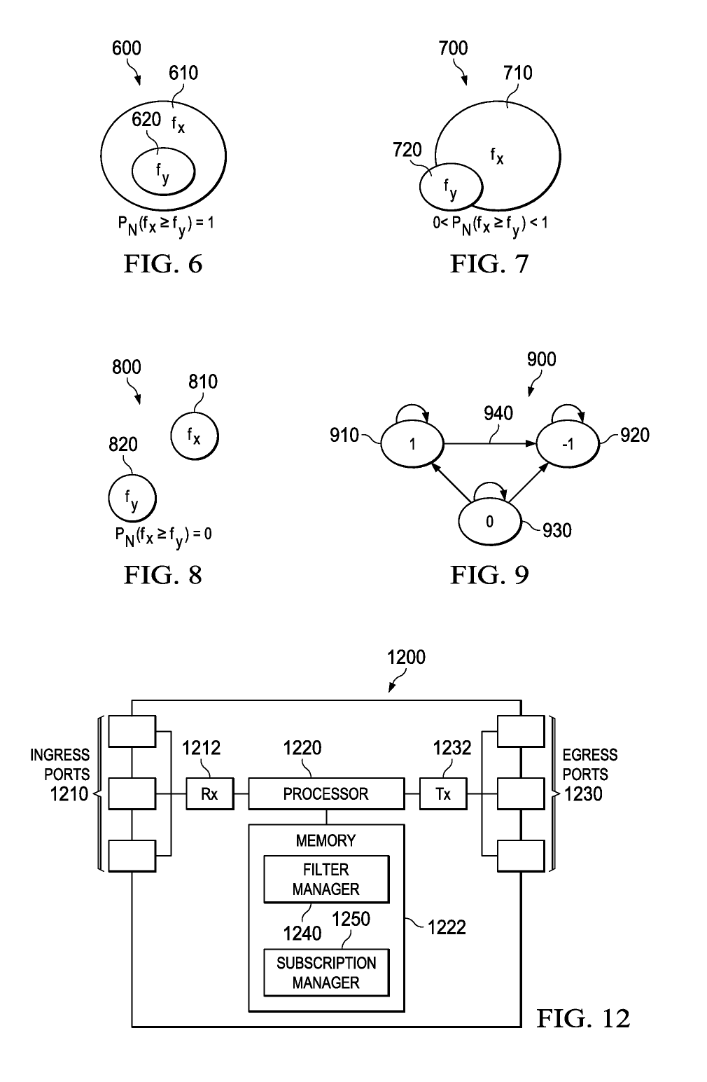

The event broker 320 creates the plurality of filters 360 upon receipt of subscriptions from the child node 370 and the plurality of filters 360 from a package server (not shown), which is described in further details in FIG. 4 and FIG. 5. The event broker 320 further manages the filters 360 via the filter SPI 350 so that the event broker 320 may invoke the filters 360 through the filter SPI 350 without knowing the filter languages of the filters 360. The filter manager 330 is configured to determine the filter-covering relationships between any two of the filters 360 by comparing a number of notifications 325 that satisfy each of the filters 360. The notifications 325 for determining the filter-covering relationships may be originally from the event sources 310 (e.g., the client 210E and the client 201F), event source simulators 315 (not shown), or both. The event source simulators 315 are configured similar to the event sources 310 but may only transmit notifications according to the filters 360 for determining the filter-covering relationship. Further details about determining the filter-covering relationships are described in FIGS. 6-11 and Tables 2-7. After the filter-covering relationship is determined, the filter manager 330 records the filter-cover relationship in, for example, the data structure 335 and stores the data structure 335 in a memory of the event broker 320. The subscription manager 340 is configured to inform the parent node 380 of unsubscribing the covered filters based on the data structure 335 in order to reduce redundant notifications corresponding to the covered filters as described in table 8. For example, when it is determined that a first filter covers a second filter, the subscription manager 340 informs the parent node 380 of unsubscribing the second filter.

FIG. 4 is a protocol diagram illustrating filter deployment 400 according to an embodiment of the disclosure. The protocol diagram 400 illustrates message exchanges between an event sink 410 (e.g., the client 210A or the client 210B), a package server 420, and an event broker 430 (e.g., the event broker 320) for deploying a plurality of filters 450 and 460 (e.g., the filters 360) in the event broker 430. For simplicity, it is assumed the plurality of filters 450 and 460 include a first filter f₁ 450 and a second filter fₖ 460 although a number of the filters 450 and 460 may be any positive integer number. The method conducted in the protocol diagram 400 may be implemented when the filter covering-based notification routing is initiated. In some examples, the package server 420 is a server in communication with the event sink 410. In some examples, the package server 420 is the event sink 410. The event broker 430 includes a filter manager 440 (e.g., the filter manager 330) and a filter registration 470.

In an embodiment, the plurality of filters 450 and 460 may be deployed in the event broker 430 after subscriptions 412. The event sink 410 transmits the subscriptions 412 (“[POST/subscriptions Package_URI, Filter_URI]”) to the filter manager 440. The subscriptions 412 indicate a package uniform resource identifier (URI) (Package_URI) and a filter URI (Filter_URI). The plurality of filters 450 and 460 are packed in a filter package in the package server 420. The Package_URI identifies a name of the filter package stored in the package server 420. The Filter_URI includes a URI for each of the filters 450 and 460.

In response to the subscriptions 412, the filter manager 440 transmits a request 422 for the filter package with a message “GET Package_URI” according to the Package_URI to the package server 420. The package server 420 transmits the filter package 424 to the filter manager 440 in response to the request 422 for the filter package 424. Following receipt of the filter package 424, the filter manager 440 unpacks the filter package 424 and obtains the plurality of the filters 450 and 460 according to the Filter_URI with a procedure “[unpack (Filter Class, Filter_URI)]” 426. Each of the plurality of filters 450 and 460 may be defined as a filter class.

Next, the filter manager 440 creates (e.g., instantiates objects from a class) the plurality of filters 450 and 460 and registers the plurality of filters 450 and 460 in the filter registration 470 one by one. For example, the filter manager 440 creates f₁ 450 by creating a first new filter object 442 named f₁ and storing f₁ 450 in the event broker 430. The filter manager 440 further registers f₁ 450 in the filter registration 470 with a procedure “register(URI_1, f₁)” 444, where URI_1 is the URI of f₁ 450. Similarly, the filter manager 440 creates fₖ 460 by creating a second new filter object 446 named fₖ and storing fₖ 460 in the event broker 430. The filter manager 440 further registers fₖ 460 in the filter registration 470 with a procedure “register(URI_k, fₖ)” 448, where URI_k is the URI of fₖ 460.

After all the filters 450 and 460 have been registered in the filter registration 470, the filter registration 470 designates a filter SPI (e.g., the filter SPI 350) to manage the plurality of filters 450 and 460 so that the event broker 430 may invoke the filters 450 and 460 through the filter SPI without knowing the filtering languages of the filters 450 and 460. The filter manager 440 then transmits a message “[201 Created]” 452 to the event sink 410 indicating the plurality of filters 450 and 460 are deployed in the event broker 430. The protocol is concluded after transmission of the message 452.

In an embodiment, the plurality of filters 450 and 460 may be deployed in the event broker 430 before subscriptions 455. The method for this embodiment is similar to the method described above except for two differences. First, the event sink 410 initially transmits a filter registration message 411 ([POST/filter_registration Package_URI]) to the filter manager 440 rather than the subscriptions 412 (“[POST/subscriptions Package_URI, Filter_URI]”). The filter registration message 411 indicates the package_URI. Second, in response to the message ([201 Created]) 452, the event sink 410 further transmits the subscriptions 455 ([POST/subscriptions Filter_URI]) to the filter manager 440, where Filter_URI indicates the URIs of the plurality of filters 450 and 460 deployed in the event broker 430. The protocol is concluded after transmission of the subscriptions 455.

FIG. 5 is a schematic diagram of an event broker configuration 500 according to an embodiment of the disclosure. The event broker configuration 500 illustrates an event broker 530 (e.g., the event broker 430) configured to deploy a plurality of filters 550 and 560. For simplicity, the plurality of filters 550 and 560 include two filters such as f₁ 550 and fₖ 560 similar to f₁ 450 and fₖ 460 although the plurality of filters 550 and 560 may include any positive integer number of the filters 550 and 560. The event broker 530 comprises the filter manager 540 (e.g., the filter manager 440), a subscription manager 590 (e.g., the subscription manager 340) coupled to the filter manager 540, the filter registration 570 (e.g., the filter registration 470) coupled to the filter manager 540 and the subscription manager 590, a filter SPI 575 (e.g., the filter SPI 350) coupled to the filter registration 570, and the plurality of filters 550 and 560 accessible to the filter manager 540 and the filter SPI 575. The event broker 530 may be configured as shown or in any other suitable manner.

The filter manager 540 receives a filter package 524 (e.g., the filter package 424) from a package server (e.g., the package server 420). In an embodiment, the filter package 524 may be expressed by docker images in the open-source docker container technology. In an embodiment, the filter package 524 may be a web application archive (WAR) file as shown in FIG. 5, which is written in an extensible markup language (XML) and indicates a filter name, a filter class, and a URI for each of the filters packed in the filter package 524.

Following receipt of the filter package 524, the filter manager 540 creates the plurality of filters 550 and 560, and registers the plurality of filters 550 and 560 in the filter registration 570. In an embodiment, the filter manager 540 may instruct the filter registration 570 to add the filters 550 and 560 using a procedure “add_filter(Filter_object, Filter_URI),” where Filter_object may refer to the names of the filters 550 and 560. In an embodiment, the filter manager 540 may instruct the filter registration 570 to remove the plurality of the filters 550 and 560 using a procedure “remove_filter(Filter_URI).”

The filter registration 570 further designates the filter SPI 575 to manage the plurality of the filters 550 and 560 so that the event broker 530 may invoke the filters 550 and 560 through the filter SPI 575 without knowing the filtering languages of the filters 550 and 560. The filters 550 and 560 may be used through the filter SPI 575 with a procedure “filter(context, notification).” The notification 580 may be obtained by using a procedure “get_content( )” The context 520 may be any additional information not indicated in the notification 580. For example, the context 520 may indicate a specific time that the filters 550 and 560 may be used in a different way from other time through the filter SPI 575. Such context 520 may be obtained by using a procedure “get_timestamp( )” For another example, the context 520 may indicate an event source of the notification 580 (e.g., the client 210E and/or the client 210F). Such context 520 may be obtained by using a procedure “get_source( ).”

In an embodiment, the procedure “filter(context, notification)” may return a binary number or a Boolean value (true or false) indicating a filtering result of the notification 580 in the context 520. For example, the binary number may be 1 when the notification 580 satisfies the filter (e.g., the filter 550 or 560) in the context 520. For another example, the binary number may be 0 when the notification 580 does not satisfy the filter (e.g., the filter 550 or 560) in the context 520.

The filter manager 540 further receives subscriptions 512 (e.g., the subscriptions 412 or the subscriptions 455). The subscriptions 512 may indicate Filter_URI, the expiry of the subscriptions 512, and a URI of an event sink (e.g., the event sink 410) which transmits the subscriptions 512. Following receipt of the subscription 512, the filter manager 540 forwards the subscriptions 512 to the subscription manager 590, which may add the subscription 512 according to the Filter_URI, the expiry of the subscription 512, and the URI of the event sink (e.g., the event sink 410) with a procedure “add subscription(Filter_URI, Expiry, Event sink_URI)” or remove the subscriptions 512 according to an URI of the subscription (subscription_URI) with a procedure “remove_subscription(subscription_URI).”

In an embodiment, the subscription 512 is similar to the subscription 412. The filter manager 540 may receive the filter package 524 after the subscriptions 512. In an embodiment, the subscription 512 is similar to the subscription 455. The filter manager 540 may receive the filter package 524 before the subscription 512.

After the plurality of filters (e.g., the filters 550 and 560) are deployed in the event broker (e.g., the event brokers 430 and 530), the filter manager (e.g., the filter managers 330, 440, and 540) employs a statistical model to determine the filter covering relationship between any two of the plurality of filters (e.g., the filters 360, 450, 460, 550, and 560). In the statistical model, P_{N} (filter-covering relationship) is defined as a probability when the filter-covering relationship is satisfied for a nonempty set of notifications (e.g., the notifications 580) represented by N.

FIGS. 6-8 illustrate three different filter-covering relationships, where fₓ represents a first filter (e.g., one of the filters 360, 450, 460, 550, and 560) and f_{y} represents a second filter (e.g., one of the filters 360, 450, 460, 550, and 560). Statistically, the probability that fₓ covers f_{y} may be given by:

P_{N}(fₓ≧f_{y})=P_{N}(fₓ|f_{y})=P_{N}(fₓf_{y})/P_{N}(f_{y})=(N(fₓf_{y})/|N|)/(N(f_{y})/|N|)=N(fₓf_{y})/N(f_{y}) (1)

where P_{N}(fₓ|f_{y}) represents a conditional probability that the notifications in set N satisfy fₓ if the notifications in N satisfy f_{y}, P_{N}(fₓ f_{y}) represents a joint probability that the notifications in N satisfy both fₓ and f_{y}, P_{N}(f_{y}) represents a probability that the notifications in N satisfy f_{y}, N(fₓf_{y}) represents a number of the notifications in N that satisfy both fₓ and f_{y}, |N| represents the cardinality of set N indicating the total number of the notifications in N, and N(f_{y}) represents a number of the notifications in N that satisfy f_{y}. According to equation (1), the filter manager (e.g., the filter managers 330, 440, and 540) may determine the filter-covering relationship between fₓ and f_{y} by dividing N(fₓf_{y}) by N(f_{y}) without knowing the filtering languages which express fₓ and f_{y}.

In addition, two properties of a filter-covering relationship may be derived according to equation (1). First, when a first filter covers a second filter, and a second filter covers a third filter, it is determined that the first filter covers the third filter without comparing the first filter and the third filter. Second, when a first filter covers a second filter, and the second filter covers the first filter, it is determined that the first filter is equivalent to the second filter no matter whether their filter languages are the same.

FIG. 6 is a diagram illustrating a first filter-covering relationship 600 according to an embodiment of the disclosure. A first oval 610 enclosing fₓ represents first notifications in N that satisfy fₓ. A second oval 620 enclosing f_{y} represents second notifications in N that satisfy f_{y}. As shown in FIG. 6, the first oval 610 encloses the second oval 620, indicating fₓ covers f_{y} expressed by equation P_{N}(fₓ≧f_{y})=1. According to equation (1), the first filter-covering relationship is satisfied when N(fₓf_{y}) equals to N(f_{y}) indicating the number of notifications in N that satisfy both fₓ and f_{y} is equal to the number of notifications in N that satisfy f_{y}.

FIG. 7 is a diagram illustrating a second filter-covering relationship 700 according to an embodiment of the disclosure. A first oval 710 enclosing fₓ represents first notifications in N that satisfy fₓ. A second oval 720 enclosing f_{y} represents second notifications in N that satisfy f_{y}. As shown in FIG. 7, the first oval 710 encloses only a portion of the second oval 720, indicating fₓ does not cover f_{y} expressed by inequalities 0<P_{N}(fₓ≧f_{y})<1. According to equation (1), the second filter-covering relationship is satisfied when 0<N(fₓf_{y})<N(f_{y}) indicating the number of notifications in N that satisfy both fₓ and f_{y} is larger than 0 and less than the number of notifications in N that satisfy f_{y}.

FIG. 8 is a diagram illustrating a third filter-covering relationship 800 according to an embodiment of the disclosure. A first oval 810 enclosing fₓ represents first notifications in N that satisfy fₓ. A second oval 820 enclosing f_{y} represents second notifications in N that satisfy f_{y}. As shown in FIG. 8, the first oval 810 and the second oval 820 have no overlap, indicating fₓ does not cover f_{y} and f_{y} does not cover fₓ expressed by equation P_{N}(fₓ≧f_{y})=0. According to equation (1), the third filter-covering relationship is satisfied when N(fₓf_{y})=0 indicating no notifications in N satisfy both fₓ and f_{y}.

Various methods may be employed by the filter manager (e.g., the filter manager 330, 440, and 540) to implement the statistical model above to determine the filter-covering relationships of a plurality of filters (e.g., the filters 360, 450, 460, 550, and 560). One method to implement the statistical model is described below. In this method, event sources (e.g., the event sources 310) or event source simulators (e.g., the event source simulator 315) transmit m notifications represented by N[1], N[2], . . . , N[m] to an event broker (e.g., the event brokers 320, 430, and 530) which maintains k filters represented by f₁, f₂, f₃, . . . , and fₖ in order to determine the filter-covering relationship of the k filters. Both m and k are positive integers.

A first matrix S[m+1, k] is created as shown in Table 2, which includes (m+1) rows and k columns. The columns show the k filters and the rows show the m notifications. Each of the first m rows indicates filtering results of the k filters for each of the m notifications as shown in the intersections between the columns and the rows. The filtering results are binary and may be obtained with the procedure “filter(context, notification)” as described in FIG. 5, where the context may be a default value or any other suitable value and the notification may be one of the m notifications represented by N[1], N[2], . . . , and N[m]. The filtering results in Table 2 are initially set to zero, and later updated based on received notifications. The filtering results remain zero when the corresponding notifications do not satisfy the corresponding filters, and the filtering results are one when the corresponding notifications satisfy the corresponding filters. The last row indicates a total number of notifications that satisfy each filter, which is the sum of the filtering results in each column.

TABLE 2
The first matrix S[m + 1,k]

Filters

| Notifications | f₁ | . . . | fₖ |
|---|---|---|---|
| N[1] | 0/1 | | 0/1 |
| . . . | . . . | . . . | . . . |
| N[m] | 0/1 | | 0/1 |
| Sum | N (f₁) | . . . | N (fₖ) |

In addition to the first matrix S[m+1, k], a second matrix C[k,k] is created as shown in Table 3 based on the first matrix S[m+1,k]. In the second matrix C[k,k], both the columns and the rows represent the k filters. A relationship value at each intersection of the columns and rows indicates a filter covering relationship between a first filter represented by the row and a second filter represented by the column corresponding to the intersection. The relationship values in Table 3 may be calculated based on the first matrix S[m+1, k] according to equation (1) by executing the code in Table 4. In an embodiment, the relationship values are 1 when it is determined the first filters cover the second filters based on the first matrix S[m+1,k] (e.g., as illustrated in FIG. 6). The relationship values are 0 when the filter-covering relationships between the first filters and the second filters are undetermined due to the incomplete first matrix S[m+1,k]. The relationship values are −1 when it is determined the first filters do not cover the second filters based on the first matrix S[m+1,k] (e.g., as illustrated in FIGS. 7-8).

TABLE 3
The second Matrix C[k,k]

Filters

| Filters | f₁ | . . . | fₖ |
|---|---|---|---|
| f₁ | −1/0/1 | . . . | −1/0/1 |
| . . . | . . . | . . . | . . . |
| fₖ | −1/0/1 | . . . | −1/0/1 |

The relationship values of the second matrix C[k,k] may be updated whenever the first matrix S[m+1,k] is updated by executing the code in Table 5. The procedure “compute cover(S, C, i, j)” in line 3 of table 5 is defined in lines 10-13 of Table 4.

TABLE 4
A sample of code for calculating the second matrix C[k,k]

| | |
|---|---|
| 1 | build_covers (F[k], S[m+1,k], C[k,k]) |
| 2 | for i = 0 to k−1 |
| 3 | for j = 0 to k−1 |
| 4 | if (i == j) C[i,j] = 1 |
| 5 | compute_cover(S, C, i, j) |
| 6 | End |
| 7 | End |
| 8 | End |
| 9 | |
| 10 | compute_cover (S, C, i, j) |
| 11 | if S[m+1,j] == 0 then C[i,j]=0 |
| 12 | else C[i,j]=(N(i,j)/N(j)==1)? 1: −1 |
| 13 | End |

TABLE 5
A sample of code for updating the second matrix C[k,k]

| | |
|---|---|
| 1 | update_covers(S[m+1, k], C[k,k]) |
| 2 | for each C[i,j] in C |
| 3 | cij = compute_cover(S, C, i, j) |
| 4 | if (C[i,j] == 1 and cij != 0) then |
| 5 | C[i,j] = cij |
| 6 | End |
| 7 | if (C[i,j] == 0) then |
| 8 | C[i,j] = cij |
| 9 | End |
| 10 | End |
| 11 | End |

FIG. 9 is a diagram illustrating state transitions 900 according to an embodiment of the disclosure. The diagram 900 comprises a first state 910 (e.g., a relationship value is 1), a second state 920 (e.g., the relationship value is −1), and a third state 930 (e.g., the relationship value is 0) interconnected with arrows 940. Each of the first state 910, the second state 920, and the third state 930 indicates a filter-covering relationship between a first filter and a second filter according to the corresponding relationship value. Specifically, the first state 910 indicates the first filter covers the second filter, the second state 920 indicates the first filter does not cover the second filter, and the third state 930 indicates the filter-covering relationship between the first filter and the second filter is undetermined.

Each arrow 940 indicates one state (e.g., one of the first state 910, the second state 920, and the third state 930) may transition to the other state (e.g., one of the first state 910, the second state 920, and the third state 930) according to an update of the first matrix S[m+1, k] by the procedures in Tables 4 and 5. For example, the arrow 940 shows the first state 910 may transition to the second state 920, indicating the relationship value may change from 1 to −1 after the first matrix S[m+1,k] is updated by the procedures based on a new set of notifications. As shown in FIG. 9, the relationship value may remain 1 or be updated to −1, the relationship value may remain 0 or be updated to 1 or −1, and the relationship value may remain −1.

When it is determined that the first filter covers the second filter (e.g., the relationship value equals 1 in table 3), the second filter is regarded as a redundant filter. As a result, the column representing the second filter in Table 2 and both the row and the column representing the second filter in table 3 are removed by executing the code in Table 6. In addition to remove one or more filters, the filter manager (e.g., the filter managers 330, 440, and 540) may add one or more new filters for new subscriptions by executing the code in Table 7, for example, when the one or more new filters are deployed in the event broker.

TABLE 6
A sample of code for removing a filter

1 remove_filters(F[k], S[m+1, k], C[k,k])
2 remove_col(S, F)
3 remove_col(C, F)
4 remove_row(C, F)
5 End

TABLE 7
A sample of code for removing a filter

1 add_filters(F[k], S[m+1, k], C[k,k])
2 add_col(S, F, 0)
3 add_col(C, F, 0)
4 add_row(C, F, 0)
5 update_covers(S, C)
6 End

Finally, subscriptions (e.g., the subscriptions 512) may be updated by executing the code in Table 8 due to the state transitions as shown in FIG. 9. When the first state 910 transitions to the second state 920, it is indicated that the previous determination that the first filter covers the second filter is wrong. Therefore, the subscription manager (e.g., the subscription managers 340 and 590) of the event broker (e.g., the event brokers 320, 430, and 530) instructs the parent event broker of the event broker to add a subscription corresponding to the second filter, and so on. As a result, the subscription corresponding to the second filter is added in all the event brokers between the event broker and the event sources in the path connecting the event sinks and the event sources, which are collectively represented by set “B(the second filter).” For example, set “B(the second filter)” may include the event brokers 220C-D in FIG. 2 when the event broker is the event broker 220B.

When the third state 930 transitions to the first state 910, it is indicated that the first filter covers the second filter, while the previous updates did not determine the filter-covering relationship between the first filter and the second filter. Therefore, the subscription manager (e.g., the subscription managers 340 and 590) of the event broker (e.g., the event brokers 320, 430, and 530) instructs the parent event broker of the event broker to remove the subscription corresponding to the second filter. The parent event broker continues to instruct its parent event broker until the event source is instructed to remove the subscription corresponding to the second filter. Finally, the subscription corresponding to the second filter is unsubscribed in all the event brokers of set B (the second filter) and the event source. As a result, the redundant notifications corresponding to the second filter may be reduced from the event sources.

TABLE 8
A sample of code for updating the subscriptions

| | |
|---|---|
| 1. | update_subscriptions(C[k,k], B) |
| 2 | while run do |
| 3 | events = listen(C) |
| 4 | for each e in events |
| 5 | case e: |
| 6 | [0, 1, i, j]: unsubscribe(F[j], B[F[j]]) |
| 7 | [1,−1, i, j]: subscribe(F[j], B[F[j]]) |
| 8 | End |
| 9 | End |
| 10 | End |
| 11 | End |

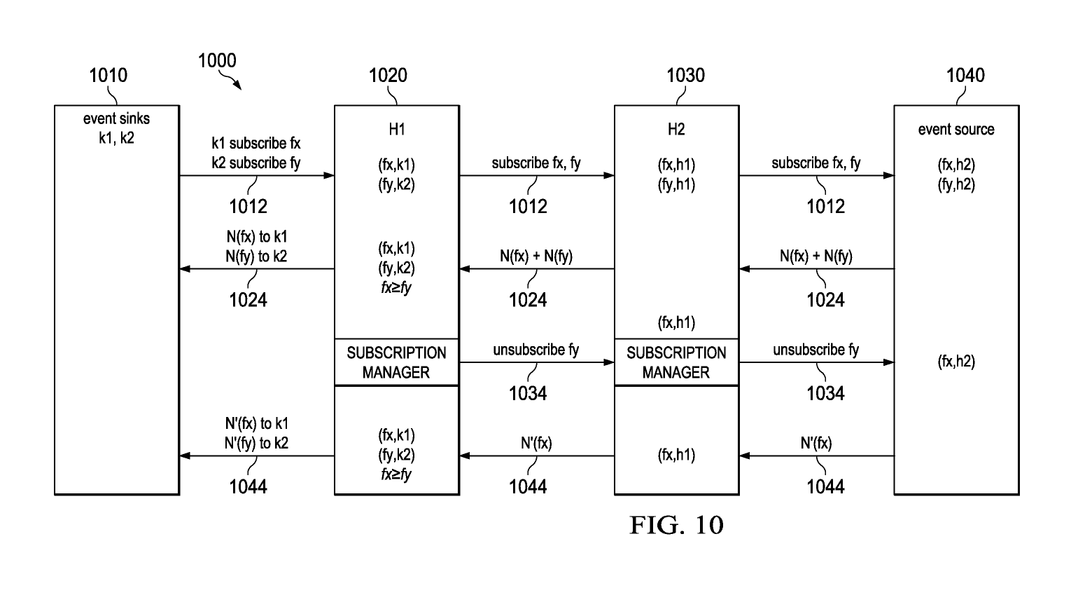

FIG. 10 is a protocol diagram illustrating filter covering-based notification routing 1000 according to an embodiment of the disclosure. The protocol diagram 1000 may be implemented in a distributed event-based system when the filter covering-based notification routing is initiated. The distributed event-based system comprises event sinks 1010, a first event broker H1 1020 coupled to the event sinks 1010, a second event broker H2 1030 coupled to the first event broker H1 1020, and an event source 1040 coupled to the second event broker 1030. The event sinks 1010 include a first event sink k1 and a second event sink k2 configured to transmit subscriptions and receive notifications corresponding to the subscriptions, which are similar to client 210A and client 210B. The first event broker H1 1020 is similar to event brokers 320, 430, and 530 and is configured to implement the statistical model to determine the filter-covering relationships. The second event broker H2 1030 is similar to the first event broker H1 1020. However, the second event broker H2 1030 does not participate in the implementation of the statistical model for determining the filter-covering relationships illustrated in FIG. 10. The event source 1040 is similar to client 210E and client 210F and is configured to receive subscriptions and transmit notifications according to the subscriptions. The protocol diagram 1000 illustrates the implementation of the statistic model in the first event broker H1 1020 for reducing redundant notifications from the event source 1040.

Event sinks 1010 forward subscriptions 1012 to the first event broker H1 1020. Specifically, the subscriptions 1012 include a first subscription and a second subscription. The first event sink k1 and the second event sink k2 send the first subscription and the second subscription to the first event broker H1 1020, respectively. Before or after receipt of the subscriptions 1012, the first event broker H1 1020 receives a first filter fₓ corresponding to the first subscription and a second filter f_{y} corresponding to the second subscription from a package server (e.g., the package server 420). In response to the subscriptions 1012, the first event broker H1 1020 creates the first filter fₓ with a record “(fₓ, k1)” indicating that the first subscription corresponding to the first filter fₓ is forwarded from the first event sink k1 to the first event broker 1020. The first event broker H1 1020 further creates the second filter f_{y} with a record “(f_{y}, k2)” indicating that the second subscription corresponding to the second filter f_{y} is forwarded from the second event sink k2 to the first event broker 1020. After both the first filter f_{y} and the second filter f_{y} are created in the first event broker H1 1020, the first event broker H1 1020 forwards the subscriptions 1012 to the second event broker 1030.

Before or after receipt of the subscriptions 1012, the second event broker H2 1030 receives the first filter fₓ and the second filter f_{y} from the package server (e.g., the package server 420). In response to the subscriptions 1012, the second event broker H2 1030 creates the first filter fₓ with a record “(fₓ, h1)” indicating that the first subscription corresponding to the first filter fₓ is forwarded from the first event broker H1 1020 to the second event broker H2 1030. The second event broker H2 1030 further creates the second filter f_{y} with a record “(f_{y}, h1)” indicating the second subscription corresponding to the second filter f_{y} is forwarded from the first event broker H1 1020 to the second event broker H2 1030. After both the first filter fₓ and the second filter f_{y} are created in the second event broker H2 1030, the second event broker H2 1030 forwards the subscriptions 1012 to the event source 1040.

Before or after receipt of the subscriptions 1012, the event source 1040 receives the first filter fₓ and the second filter f_{y} from the package server (e.g., the package server 420). In response to the subscriptions 1012, the event source 1040 creates the first filter fₓ with a record “(fₓ, h2)” indicating the first subscription corresponding to the first filter fₓ is forwarded from the second event broker H2 1030 to the event source 1040. The event source 1040 further creates the second filter f_{y} with a record “(f_{y}, h2)” indicating the second subscription corresponding to the second filter f_{y} is forwarded from the second event broker H2 1030 to the event source 1040.

In order to determine the filter-covering relationship between the first filter fₓ and the second filter f_{y}, the event source 1040 or an event source simulator (e.g., the event source simulator 315) transmits notifications 1024 corresponding to the subscriptions 1012 to the second event broker H2 1030 after both the first filter fₓ and the second filter f_{y} are subscribed in the event source 1040. The notifications 1024 include first notifications corresponding to the first filter fₓ and second notifications corresponding to the second filter f_{y}. A number of the first notifications may be denoted by N(fₓ). A number of the second notifications may be denoted by N(f_{y}). Upon receipt of the notifications 1024, the second event broker H2 1030 forwards the notifications 1024 to the first event broker H1 1020.

Upon receipt of the notifications 2014, the first event broker H1 1020 forwards the first notifications to the first event sink k1 according to the record “(fₓ, k1)” and the second notifications to the second event sink k2 according to the record “(f_{y}, k2).” In the meanwhile, a filter manager (e.g., the filter managers 330 and 440) of the first event broker H1 1020 determines a filter-covering relationship between the first filter fₓ and the second filter f_{y} based on the notifications 1024. In an embodiment, the filter manager of the first event broker H1 1020 determines a first number of the notifications 1024 that satisfy both the first filter fₓ and the second filter f_{y}. The filter manager of the first event broker H1 1020 further determines a second number of the notifications 1024 that satisfy the second filter f_{y}. When the first number of the test notifications 1024 is equal to the second number of the test notifications 1024, the filter manager of the first event broker H1 1020 determines the first filter fₓ covers the second filter f_{y} (e.g., as illustrated in FIG. 6). Otherwise, the filter manager of the first event broker H1 1020 determines that the first filter fₓ does not cover the second filter f_{y} (e.g., as illustrated in FIGS. 7-8). In addition, the filter manager of the first event broker H2 1020 may further determine a third number of the notifications 1024 that satisfy the first filter fₓ. When the first number of the notifications 1024 is equal to the third number of the test notifications 1024, the first manager of the first event broker H1 1020 determines the second filter f_{y} covers the first filter fₓ. Otherwise, the filter manager of the first event broker H1 1020 determines that the second filter f_{y} does not cover the first filter fₓ.

In an embodiment, the filter manager of the first event broker H1 1020 determines a number of the first notifications that satisfy the first filter fₓ and the second filter f_{y} denoted by N(fₓf_{y}). When N(fₓf_{y}) is equal to N(f_{y}), the filter manager of the first event broker 1020 determines the first filter fₓ covers the second filter f_{y} (e.g., as illustrated in FIG. 6). Otherwise, the filter manager of the first event broker 1020 determines that the first filter fₓ does not cover the second filter f_{y} (e.g., as illustrated in FIGS. 7-8). Similarly, if N(fₓf_{y}) is equal to N(fₓ), the filter manager of the first event broker 1020 determines the second filter f_{y} covers the first filter fₓ. Otherwise, the filter manager of the filter event broker 1020 determines the second filter f_{y} does not cover the first filter fₓ.

When it is determined that the first filter fₓ covers the second filter f_{y}, a subscription manager (e.g., the subscription managers 340 and 590) of the first event broker H1 1020 transmits a request message 1034 to remove the second subscription corresponding to the second filter f_{y} to the second event broker H2 1030. In response to the message 1034, a subscription manager (e.g., the subscription manager 340, 590) of the second event broker H2 1030 removes the second subscription, for example, by executing the code in Table 8 and unsubscribe the second filter, for example, by executing the code in Table 6. The subscription manager of the second event broker H2 1030 further forwards the command 1034 to the event source 1040.

In response to the message 1034, the event source 1040 removes the second subscription. As a result, the event source 1040 transmits third notifications 1044 corresponding to the first filter fₓ to the second event broker H2 1030. As shown in FIG. 10, a number of the third notifications may be denoted by N′(fₓ). Due to the removal of the second subscription, the redundant notifications that satisfy the second filter f_{y} are therefore eliminated from the event source 1040.

The second event broker H2 1030 forwards the third notifications to the first event broker H1 1020 following receipt of the third notifications 1044. In an embodiment, the first event broker H1 1020 forwards a portion of the third notifications which satisfies the second filter f_{y} to the second event sink k2 according to the record “(f_{y}, k2).” The number of notifications in the portion of the third notification that satisfies the second filter f_{y} may be denoted by N′(f_{y}). The first event broker H1 1020 further forwards the third notifications 1044 to the first event sink k1 according to the record “(fₓ, k1)” as shown in FIG. 10.

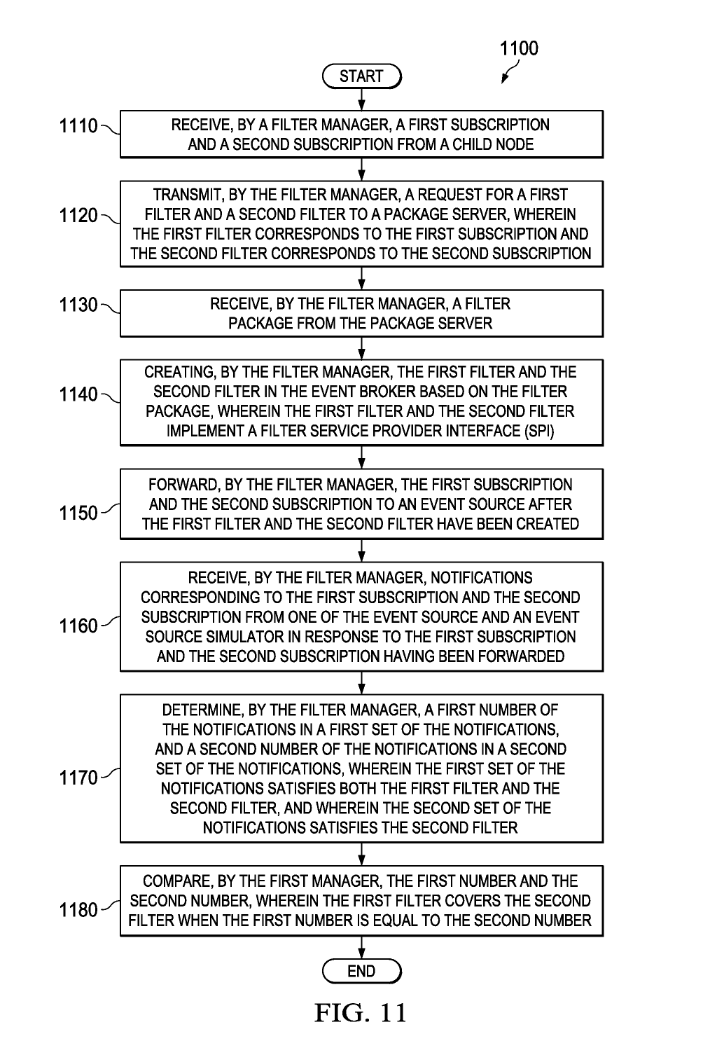

FIG. 11 is a flowchart illustrating a method of filter covering-based notification routing 1100 according to an embodiment of the disclosure. The method 1100 determines a filter-covering relationship between a first filter (e.g., f₁ 450 and f₁ 550) and a second filter (e.g., f_{K} 460 and fₖ 560) based on the output of invoking the first filter and the second filter. The method 1100 may be performed in an event broker (e.g., one of the event brokers 220A, 220B, 220C, 220D, 320, 430, and 530) before or after the event sinks (e.g., the client 210A and the client 210B) transmit subscriptions (e.g., the subscriptions 412, 455, and 1012).

At step 1110, a first subscription and a second subscription are received by a filter manager (e.g., the filter managers 330, 440, and 540) from a child node (e.g., the child node 370). The first subscription and the second subscription may be similar to the subscriptions 412. At step 1120, a request (e.g., the request 422) for a first filter and a second filter is transmitted by the filter manager (e.g., the filter managers 330, 440, and 540) to a package server (e.g., the package server 420). The first filter corresponds to the first subscription, and the second filter corresponds to the second subscription. In an embodiment, the first filter and the second filter are requested as a filter package (e.g., the filter packages 424 and 524).

At step 1130, the filter package (e.g., the filter packages 424 and 524) is received by the filter manager (e.g., the filter managers 330 and 440) from the package server (e.g., the package server 420). In an embodiment, the filter package is a WAR file. Step 1110 may take place before the step 1120. Alternatively, step 1110 may take place after the step 1130.

At step 1140, the first filter and the second filter are created in the event broker based on the filter package by the filter manager (e.g., the filter manager 330 and 440). The first filter and the second filter may implement a filter SPI (e.g., the filter SPIs 350 and 575) so that the event broker may invoke the first filter and/or the second filter through the filter SPI without knowing the filtering languages of the first filter and/or the second filter.

At step 1150, the first subscription and the second subscription are forwarded to an event source (e.g., the client 210E, the client 210F, the event sources 310, and the event source 1040) by the filter manager (e.g., the filter managers 330 and 440) after both the first filter and the second filter have been created. At step 1160, notifications corresponding to the first subscription and the second subscription are received by the filter manager (e.g., the filter managers 330, 440, and 540) in response to the first subscription and the second subscription having been forwarded. In an embodiment, the notifications are received from the event sources (e.g., the client 210E, the client 210F, the event sources 310, and the event source 1040). In an embodiment, the notifications are received from the event source simulator (e.g., the event source simulator 315).

At step 1170, a first number of the notifications in a first set of the notifications and a second number of the notifications in a second set of the notifications are determined by the filter manager (e.g., the filter managers 330 and 440). The first set of the notifications satisfies both the first filter and the second filter. The second set of the notifications satisfies the second filter. At step 1180, the first number and the second number are compared by the filter manager (e.g., the filter managers 330, 440, and 540). Based on the comparison, the filter-covering relationship between the first filter and the second filter is determined by the filter manager. For example, it is determined that the first filter covers the second filter when the first number is equal to the second number (e.g., as indicated in FIG. 6). In addition, it is determined that the first filter does not cover the second filter when the first number is less than the second number (e.g., as indicated in FIGS. 7-8).

FIG. 12 is a schematic diagram of a network element (NE) 1200 according to an embodiment of the disclosure. The NE 1200 is suitable for implementing the event brokers 320 and 430 and at least one of the event brokers 220A-D. The NE 1200 includes ingress ports 1210 and a receiver unit (Rx) 1212 for receiving data, a processor 1220 to process the data; a transmitter unit (Tx) 1232 and egress ports 1230 for transmitting the data; and a memory 1222 for storing the data. The NE 1200 may also include optical-to-electrical (OE) components and electrical-to-optical (EO) components coupled to the ingress ports 1210, the Rx 1212, the Tx 1232, and the egress ports 1230 for ingress or egress of optical or electrical signals. It should be noted that the ingress ports 1210 and the egress ports 1230 may be bidirectional ports and/or may be combined into a single bi-directional port in some embodiments.

The processor 1220 may be implemented by hardware and software. The processor 1220 may be implemented as one or more CPU chips, cores (for example, as a multi-core processor), field-programmable gate arrays (FPGAs), application specific integrated circuits (ASICs), and digital signal processors (DSPs). The processor 1220 is in communication with the Rx 1212, the Tx 1232, and the memory 1222.

The memory 1222 includes one or more disks, tape drives, and solid-state drives and may be used as an over-flow data storage device, to store programs when such programs are selected for execution, and to store instructions and data that are read during program execution. The memory 1222 may be volatile and non-volatile and may be read-only memory (ROM), random-access memory (RAM), ternary content-addressable memory (TCAM), and static random-access memory (SRAM). In an embodiment, a filter manager module 1240 (e.g., the filter managers 330 and 440) and a subscription manager module 1250 (e.g., the subscription managers 340 and 590) are implemented as instructions stored in the memory 1222 such that when executed by the processor 1220, or implemented in part in the processor 1220 and in part in the memory 1222 causes the processor 1220 to perform the method 1100.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A filter manager of an event broker, comprising:
a receiver configured to receive a package uniform resource identifier (URI) from an event sink, wherein the package URI links to a filter package stored in a package server, and wherein the filter package includes URIs of a plurality of filters;
a processor operably coupled to a memory and the receiver, wherein the processor is configured to:
transmit a request for the filter package to the package server according to the package URI;
receive the filter package from the package server in response to the request for the filter package; and
unpack the filter package to obtain the plurality of filters according to the URIs of the plurality of filters following receipt of the filter package.

2. The filter manager of claim 1, wherein the processor is further configured to create a first filter of the plurality of filters based on a URI of the first filter.

3. The filter manager of claim 2, wherein the processor is further configured to register the first filter according to the URI of the first filter in a filter registration module of the event broker.

4. The filter manager of claim 3, wherein the processor is further configured to inform the event sink when the plurality of filters have been created and registered in the event broker.

5. The filter manager of claim 4, wherein the processor is further configured to receive subscriptions from the event sink after informing the event sink.

6. The filter manager of claim 5, wherein the subscriptions include the URIs of the plurality of filters.

7. The filter manager of claim 1, wherein the package URI is included in subscriptions from the event sink.

8. The filter manager of claim 1, wherein the filter package is a web application archive (WAR) file.

9. A method for filter covering-based notification routing implemented in an event broker, comprising:
receiving, by a filter manager, a first subscription and a second subscription from a child node;
transmitting, by the filter manager, a request for a first filter and a second filter to a package server, wherein the first filter corresponds to the first subscription and the second filter corresponds to the second subscription;
receiving, by the filter manager, a filter package from the package server;
creating, by the filter manager, the first filter and the second filter in the event broker based on the filter package, wherein the first filter and the second filter implement a filter service provider interface (SPI);
forwarding, by the filter manager, the first subscription and the second subscription to an event source after the first filter and the second filter have been created;
receiving, by the filter manager, notifications corresponding to the first subscription and the second subscription from one of the event source and an event source simulator in response to the first subscription and the second subscription having been forwarded;
determining, by the filter manager, a first number of the notifications in a first set of the notifications and a second number of the notifications in a second set of the notifications, wherein the first set of the notifications satisfies both the first filter and the second filter, and wherein the second set of the notifications satisfies the second filter; and
comparing, by the first manager, the first number and the second number, wherein the first filter covers the second filter when the first number is equal to the second number.

10. The method of claim 9, further comprising:
transmitting, by a subscription manager, a message to unsubscribe the second filter to the event source when the first filter covers the second filter;
receiving, by the filter manager, new notifications corresponding to the first filter from the event source in response to the message;
forwarding, by the filter manager, a portion of the new notifications to the child node, wherein the portion of the new notifications satisfies the second filter; and
forwarding, by the filter manager, the new notifications to the child node.

11. The method of claim 10, wherein the child node is a child event broker.

12. The method of claim 10, wherein the child node comprises at least one event sink.

13. The method of claim 9, wherein forwarding, by the filter manager, the first subscription and the second subscription to the event source after the first filter and the second filter have been created comprises forwarding, by the filter manager, the first subscription and the second subscription to the source through at least one parent event broker after the first filter and the second filter have been created.

14. The method of claim 9, wherein receiving, by the filter manager, the notifications according to the first subscription and the second subscription from the one of the event source and the event source simulator in response to the first subscription and the second subscription having been forwarded comprises receiving, by the filter manager, the notifications according to the first subscription and the second subscription from the one of the event source and the event source simulator through at least one parent event broker in response to the first subscription and the second subscription having been forwarded.

15. An event broker, comprising:
a receiver configured to receive a first subscription and a second subscription from a child node;
a processor operably coupled to a memory and the receiver, wherein the processor is configured to:
transmit a request for a first filter and a second filter to a package server, wherein the first filter corresponds to the first subscription and the second filter corresponds to the second subscription;
receive a filter package from the package server;
create the first filter and the second filter in the event broker based on the filter package, wherein the first filter and the second filter implement a filter service provider interface (SPI);
forward the first subscription and the second subscription to an event source after the first filter and the second filter have been created;
receive notifications corresponding to the first subscription and the second subscription from one of the event source and an event source simulator in response to the first subscription and the second subscription having been forwarded;
determine a first number of the notifications in a first set of the notifications and a second number of the notifications in a second set of the notifications, wherein the first set of the notifications satisfies both the first filter and the second filter, and wherein the second set of the notifications satisfies the second filter; and
compare the first number and the second number, wherein the first filter covers the second filter when the first number is equal to the second number.

16. The event broker of claim 15, wherein the processor is further configured to:
transmit a message to unsubscribe the second filter to the event source when the first filter covers the second filter; and
receive new notifications corresponding to the first filter from the event source in response to the message.

17. The event broker of claim 16, wherein the processor is further configured to:
forward a portion of the new notifications to the child node, wherein the portion of the new notifications satisfies the second filter; and
forward the new notifications to the child node.

18. The event broker of claim 15, wherein the child node is a child event broker.

19. The event broker of claim 15, wherein the child node comprises at least one event sink.

20. The event broker of claim 15, wherein forwarding the first subscription and the second subscription to the event source after the first filter and the second filter have been created comprises forwarding the first subscription and the second subscription to the source through at least one parent event broker after the first filter and the second filter have been created.
